(19) United States
(12) Patent Application Publication
(10) Pub. No.: US 2021/0078350 A1
(43) Pub. Date: Mar. 18, 2021

(54) LITHOGRAPHIC PRINTING PLATE PRECURSOR AND METHOD OF USE

(71) Applicant: Eastman Kodak Company, Rochester, NY (US)

(72) Inventors: Philipp Viehmann, Gottinnen (DE); WernerSaiia Werner, Hattorf (DE); Christooher D. Simpson, Osterode (DE)

(21) Appl. No.: 16/572,731

(22) Filed: Sep. 17, 2019

(51) Int. Cl. B41N 1/08; B41C 1/10

(52) U.S. Cl. CPC B41N 1/083; B41C 1/1016

(57) ABSTRACT

IR-sensitive lithographic printing plate precursors provide a high contrast and stable printout image using an IR radiation-sensitive composition. This composition includes: a free radically polymerizable component, an IR absorber, an initiator composition, color-forming compound(s) such as a specific leuco dye, and compound(s) represented by the following Structure (P):

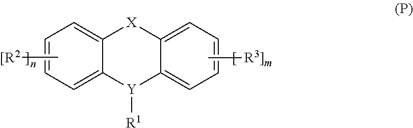

wherein X is —O—, —S—, —NH—, or —CH₂—, Y is >N— or >CH—, R¹ is hydrogen or an alkyl, R² and R³ are independently halo, thioalkyl, thiophenyl, alkoxy, phenoxy, alkyl, phenyl, thioacetyl, or acetyl, and m and n are independently 0 or an integer of 1 to 4. The printout image exhibits a color contrast between the exposed and non-exposed regions of a ΔE greater than 8. A ΔE of at least 5 is maintained between the exposed and the non-exposed regions with exposure to white light for at least one hour. These precursors, when IR-exposed, can be developed on-press.

### FIELD OF THE INVENTION

This invention relates to negative-working lithographic printing plate precursors that can be imaged in an infrared radiation-sensitive image-recording layer using infrared radiation to provide imaged lithographic printing plates. Such precursors include unique compositions that provide a stable printout image exhibiting a ΔE greater than 8 between exposed and non-exposed regions in the exposed infrared radiation-sensitive image-recording layer.

### BACKGROUND OF THE INVENTION

In lithographic printing, lithographic ink receptive regions, known as image areas, are generated on a hydrophilic surface of a planar substrate such as an aluminum-containing substrate. When the printing plate surface is moistened with water and a lithographic printing ink is applied, hydrophilic regions retain the water and repel the lithographic printing ink, and the lithographic ink receptive image regions accept the lithographic printing ink and repel the water. The lithographic printing ink is transferred to the surface of a material upon which the image is to be reproduced, perhaps with the use of a blanket roller in a printing press.

Negative-working lithographic printing plate precursors useful to prepare lithographic printing plates typically comprise a negative-working radiation-sensitive image-recording layer disposed over the hydrophilic surface of the substrate. Such an image-recording layer includes radiation-sensitive components that can be dispersed in a suitable polymeric binder material. After the precursor is imagewise exposed to suitable radiation to form exposed regions and non-exposed regions in the image-recording layer, the non-exposed regions are removed by suitable means, revealing the underlying hydrophilic surface of the substrate. The exposed regions of the image-recording layer that are not removed are lithographic ink-receptive, and the hydrophilic substrate surface revealed by the developing process accepts water and aqueous solutions such as a fountain solution and repels lithographic printing ink.

In recent years, there has been an increased desire in the lithographic printing industry for simplification in making lithographic printing plates by carrying out development on-press (“DOP”) using a lithographic printing ink or fountain solution, or both, to remove non-exposed regions of the image-recording layer. Thus, use of on-press developable lithographic printing plate precursors is being adopted more and more in the printing industry due to many benefits over traditionally processed lithographic printing plate precursors, including less environmental impact and savings on processing chemicals, processor floor space, and operation and maintenance costs. After laser imaging, on-press developable precursors can be taken directly to lithographic printing presses without the step of removing the non-exposed regions of the imaged precursors.

It is highly desirable that the imaged lithographic printing plate precursors have different colors in the exposed regions and non-exposed regions of the image-recording layer for readability before going to the printing press. The color difference between the exposed regions and the non-exposed regions is typically called “printout” (or “print-out”) or a “printout image.” A strong printout will make it easier for operators to visually identify the imaged lithographic printing plate precursors and to properly attach them to printing press units.

Many approaches have been taken in the industry to improve the printout of on-press developable printing plate precursors both immediately after imaging and after aging under ambient light. Conventionally developed precursors using an aqueous developer (wet processing) have been designed with incorporated pigments to ensure high contrast between exposed regions and non-exposed regions for readability for the eye as well as automatic camera systems. However, for on-press developable precursors, printout must be generated using a different concept that is usually based on acid-sensitive leuco dyes that can be switched by irradiation to form a color difference between exposed regions and non-exposed regions. The contrast generated by this concept is much lower than the contrast obtained in wet processed plates and an improvement is needed to achieve a printout image that can be stably detected by automated camera systems.

However, using more sensitive color forming compositions inevitably increases the sensitivity of the lithographic printing plate precursor towards white light. This increased white light sensitivity will cause increased color formation in the non-image areas if the lithographic printing plate precursor is exposed to white light after imaging. This undesirable result obviously reduces the contrast and decreases readability of the printout image.

Introduction of “stabilizer” compounds into the image-recording layer can reduce its sensitivity to white light because such stabilizer compound can reduce the sensitivity of the coating to white light and therefore reduce background color formation. But such stabilizer compounds cannot differentiate between background (non-exposed regions) and exposed regions and thereby reduce sensitivity and color formation in the exposed regions as well. Thus, contrast remains low in such precursors as well.

U.S. Patent Application Publication 2009/0047599 (Horne et al.) describes the use of spirolactone or spirolactam colorant precursors to provide printout images. There has been a need in the art to improve such printout compositions for various properties.

U.S. patent application Ser. No. 16/137,676 (filed Sep. 21, 2018 by Igarashi, et al.) describes negative-working lithographic printing plate precursors that exhibit improved printout because of the presence of an acid generator, a tetraaryl borate, an acid-sensitive dye precursor, and an aromatic diol having an electron withdrawing substituent.

U.S. Pat. No. 7,955,682 (Gore) describes an optical recording medium having a markable coating on a substrate, which markable coating includes a leuco dye and developer precursor that responds to heat or light to develop the leuco dye to form a readable pattern. Cols. 4-8 provide a lengthy list of leuco dyes that are said to be useful in such articles. There is no suggestion that such compounds would be useful in lithographic printing plate precursors to provide improved printout images that are stable under white light.

EP 2,018,365A1 (Nguyen et al.) describes lithographic printing plate precursors that can include thermally reactive iodonium salts, leuco dyes, and stabilizers in order to provide pre-exposure keeping during storage.

EP 3,418,332A1 (Inasaki et al.) describes a chromogenic composition used in a planographic plate imaging layer that allegedly has good color stability upon aging. The chromogenic composition includes a compound of Formula (1), shown at [0015] and [0303] and following sections. However, this publication is directed to a solution to a problem that arises from the use of specific infrared dyes that are able to form a strong and stable print-out by irradiation. The publication demonstrates the use of these specific IR dyes and that some known leuco dyes, such as GN-169 (Color forming compound 8 shown below) and Red-40, do not sufficiently provide a print-out image.

However, there is a need for coloration (printout) compositions that can be used to provide printout images without being limited to the use of specific infrared radiation dyes, and which printout images are less susceptible to reduction of contrast upon ambient light storage of the imaged lithographic printing plates.

### SUMMARY OF THE INVENTION

The present invention provides a lithographic printing plate precursor comprising an aluminum-containing substrate, and an infrared radiation-sensitive image-recording layer disposed on the aluminum-containing substrate,
the infrared radiation-sensitive image-recording layer comprising:
a) one or more free radically polymerizable components;
b) one or more infrared radiation absorbers;
c) an initiator composition;
d) one or more color-forming compounds;
e) one or more compounds, each being represented by the following Structure (P):

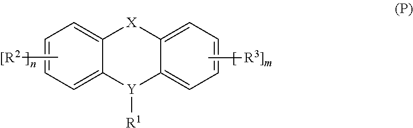

wherein X is the group —O—, —S—, —NH—, or —CH₂—, Y is the group >N— or >CH—, R¹ is hydrogen or a substituted or unsubstituted alkyl, R² and R³ are independently halo, thioalkyl, thiophenyl, alkoxy, phenoxy, alkyl, phenyl, thioacetyl, or acetyl, groups, and m and n are independently 0 or an integer of from 1 to 4; and
f) optionally, a non-free radically polymerizable polymeric material different from the a), b), c), d), and e) components defined above,

wherein the infrared radiation-sensitive image-recording layer, upon exposure to infrared radiation to provide exposed regions and non-exposed regions, exhibits a color contrast between the exposed regions and non-exposed regions of a ΔE greater than 8, and wherein a ΔE of at least 5 is maintained between the exposed regions and the non-exposed regions after storage of the exposed image-recording layer under white light for at least one hour.

In addition, the present invention provides a method for providing a lithographic printing plate, comprising:

A) imagewise exposing the lithographic printing plate precursor according to any embodiment of the present invention to infrared radiation, to provide exposed regions and non-exposed regions in the infrared radiation-sensitive image-recording layer, and

B) removing the non-exposed regions in the infrared radiation-sensitive image-recording layer from the aluminum-containing substrate on-press.

The present invention is directed to an approach for providing printout images that is not limited to the use of specific IR dyes. The present invention utilizes leuco dyes that are able to switch from a colorless form to a colored form by reaction with acid generated during infrared irradiation. Many leuco dyes are known and some of them form decent printout images by irradiation. However, the present invention is the result of innovative identification of leuco dyes that exhibit greater color changes for a given amount of acid generated in the radiation sensitive composition than the well-known compounds. In the composition used in the present invention, these leuco dyes were found to be capable of forming strong initial printout images without the presence of special IR dyes. Meanwhile, the inventive infrared radiation-sensitive formulations having increased sensitivity include a d) color-forming compound and e) a compound represented by the Structure (P) shown below, combined with the b) infrared radiation absorber and c) initiator composition to provide high contrast and stability of the resulting printout images.

### DETAILED DESCRIPTION OF THE INVENTION

The following discussion is directed to various embodiments of the present invention and while some embodiments can be desirable for specific uses, the disclosed embodiments should not be interpreted or otherwise considered to limit the scope of the present invention, as claimed below. In addition, one skilled in the art will understand that the following disclosure has broader application than is explicitly described in the discussion of any specific embodiment.

### Definitions

As used herein to define various components of the infrared radiation-sensitive image-recording layer, and other materials used in the practice of this invention, unless otherwise indicated, the singular forms “a,” “an,” and “the” are intended to include one or more of the components (that is, including plurality referents).

Each term that is not explicitly defined in the present application is to be understood to have a meaning that is commonly accepted by those skilled in the art. If the construction of a term would render it meaningless or essentially meaningless in its context, the term should be interpreted to have a standard dictionary meaning.

The use of numerical values in the various ranges specified herein, unless otherwise expressly indicated, are to be considered as approximations as though the minimum and maximum values within the stated ranges were both preceded by the word “about.” In this manner, slight variations above and below the stated ranges may be useful to achieve substantially the same results as the values within the ranges. In addition, the disclosure of these ranges is intended as a continuous range including every value between the minimum and maximum values as well as the end points of the ranges.

Unless the context indicates otherwise, when used herein, the terms “lithographic printing plate precursor,” “precursor,” and “IR-sensitive lithographic printing plate precursor” are meant to be equivalent references to embodiments of the present invention.

As used herein, the term “infrared radiation absorber” refers to a compound or material that absorbs electromagnetic radiation in the near-infrared (near-R) and infrared (IR) regions of the electromagnetic spectrum, and it typically refers to compounds or materials that have an absorption maximum in the near-IR and IR regions.

As used herein, the terms “near-infrared region” and “infrared region” refers to radiation having a wavelength of at least 750 nm and higher. In most instances, the terms are used to refer to the region of the electromagnetic spectrum of at least 750 nm and more likely of at least 750 nm and up to and including 1400 nm.

For the purposes of this invention, a printout image is generally demonstrated by a color contrast between exposed regions and non-exposed regions of an exposed infrared radiation-sensitive image-recording layer of a ΔE greater than 8, or even greater than 10. The E values of exposed regions and non-exposed regions used to obtain this ΔE value (or difference) can be measured for example, using a Techkon Spectro Dens spectral densitometer, calculating the Euclidean distance of the measured color space parameters as described in EN ISO 11664-4 “Colorimetry—Part 4: CIE 1976 L*a*b* Colour space.” CIELAB L*, a*, and b* values described herein have the known definitions according to the noted publication or later known versions and can be calculated using a standard D65 illuminant and known procedures. These values can be used to express a color as three numerical color values: L* for the lightness (or brightness) of the color, a* for the green-red component of the color, and b* for the blue-yellow component of the color values.

For clarification of definitions for any terms relating to polymers, reference should be made to “Glossary of Basic Terms in Polymer Science” as published by the International Union of Pure and Applied Chemistry (“IUPAC”), Pure Appl. Chem. 68, 2287-2311 (1996). However, any definitions explicitly set forth herein should be regarded as controlling.

As used herein, the term “polymer” is used to describe compounds with relatively large molecular weights formed by linking together many small reactive monomers. These polymer chains usually form coiled structures in a random fashion. With the choice of solvents, a polymer can become insoluble as the chain length grows and become polymeric particles dispersed in the solvent medium. These particle dispersions can be very stable and useful in infrared radiation-sensitive imagable layers described for use in the present invention. In this invention, unless indicated otherwise, the term “polymer” refers to a non-crosslinked material. Thus, crosslinked polymeric particles differ from the non-crosslinked polymeric particles in that the latter can be dissolved in certain organic solvents of good solvating property whereas the crosslinked polymeric particles may swell but do not dissolve in the organic solvent because the polymer chains are connected by strong covalent bonds.

The term “copolymer” refers to polymers composed of two or more different repeating or recurring units that are arranged along the polymer chain.

The term “backbone” refers to the chain of atoms in a polymer to which a plurality of pendant groups can be attached. An example of such a backbone is an “all carbon” backbone obtained from the polymerization of one or more ethylenically unsaturated polymerizable monomers.

As used herein, the term “ethylenically unsaturated polymerizable monomer” refers to a compound comprising one or more ethylenically unsaturated (—C═C—) bonds that are polymerizable using free radical or acid-catalyzed polymerization reactions and conditions. It is not meant to refer to chemical compounds that have only unsaturated —C═C— bonds that are not polymerizable under these conditions.

Unless otherwise indicated, the term “weight %” refers to the amount of a component or material based on the total solids of a composition, formulation, or layer. Unless otherwise indicated, the percentages can be the same for either a dry layer or the total solids of the formulation or composition.

As used herein, the term “layer” or “coating” can consist of one disposed or applied layer or a combination of several sequentially disposed or applied layers. If a layer is considered infrared radiation-sensitive and negative-working, it is both sensitive to infrared radiation (as described above for “infrared radiation-absorber”) and negative-working in the formation of lithographic printing plates.

### Uses

The infrared radiation-sensitive image-recording layer compositions used according to the present invention are useful for providing printout images in imaged (or exposed) lithographic printing plate precursors, which in turn are useful for forming lithographic printing plates for lithographic printing during press operations. Lithographic printing plates can be prepared on-press or off-press according to this invention. The lithographic printing plate precursors are prepared with the structure and components described as follows.

### Lithographic Printing Plate Precursors

The precursors according to the present invention can be formed by suitable application of an infrared radiation-sensitive image-recording composition as described below to a suitable substrate (as described below) to form an infrared radiation-sensitive image recording layer that is negative-working. In general, the infrared radiation-sensitive image-recording composition (and resulting infrared radiation-sensitive image-recording layer) comprises a) one or more free radically polymerizable components, b) one or more infrared radiation absorbers, c) initiator composition; d) one or more color-forming compounds, e) one or more compounds represented by Structure (P), defined below, and optionally, f) a non-free radically polymerizable polymeric material different from all of the a), b), c), d), and e) components defined herein.

There is generally only one infrared radiation-sensitive image-recording layer in each precursor. This layer is generally the outermost layer in the precursor, but in some embodiments, there can be an outermost water-soluble hydrophilic protective layer (also known as a topcoat or oxygen barrier layer), as described below, disposed over (or directly on and in contact with) the infrared radiation-sensitive image-recording layer.

Aluminum-Containing Substrate:

The aluminum-containing substrate that is used to prepare the precursors according to this invention generally has a hydrophilic imaging-side surface, or at least a surface that is more hydrophilic than the applied infrared radiation-sensitive image-recoding layer. The substrate comprises an aluminum-containing support that can be composed of raw aluminum or a suitable aluminum alloy that is conventionally used to prepare lithographic printing plate precursors.

The aluminum-containing substrate can be treated using techniques known in the art, including roughening of some type by physical (mechanical) graining, electrochemical graining, or chemical graining, which is followed by one or more anodizing treatments. Each anodizing treatment is typically carried out using either phosphoric or sulfuric acid and conventional conditions to form a desired hydrophilic aluminum oxide (or anodic oxide) layer on the aluminum-containing support. A single aluminum oxide (anodic oxide) layer can be present or multiple aluminum oxide layers having multiple pores with varying depths and shapes of pore openings can be present. Such processes thus provide an anodic oxide layer(s) underneath an infrared radiation-sensitive image-recording layer that can be provided as described below. A discussion of such pores and a process for controlling their width is described for example, in U.S. Patent Publications 2013/0052582 (Hayashi), 2014/0326151 (Namba et al.), and 2018/0250925 (Merka et al.), and U.S. Pat. No. 4,566,952 (Sprintschuik et al.), U.S. Pat. No. 8,789,464 (Tagawa et al.), U.S. Pat. No. 8,783,179 (Kurokawa et al.), and U.S. Pat. No. 8,978,555 (Kurokawa et al.), the disclosure of all of which are incorporated herein by reference, as well as in EP 2,353,882 (Tagawa et al.). Teaching about providing two sequential anodizing treatments to provide different aluminum oxide layers in an improved substrate are described for example, in U.S. Patent Application Publication 2018/0250925 (Merka et al.), the disclosure of which is incorporated herein by reference.

Sulfuric acid anodization of the aluminum support generally provides an aluminum (anodic) oxide weight (coverage) on the surface of at least 1 g/m² and up to and including 5 g/m² and more typically of at least 3 g/m² and up to and including 4 g/m². Phosphoric acid anodization generally provides an aluminum (anodic) oxide weight on the surface of from at least 0.5 g/m² and up to and including 5 g/m² and more typically of at least 1 g/m² and up to and including 3 g/m².

An anodized aluminum-containing support can be further treated to seal the anodic oxide pores or to hydrophilize its surface, or both, using known post-anodic treatment processes, such as post-treatments using aqueous solutions of poly(vinyl phosphonic acid) (PVPA), vinyl phosphonic acid copolymers, poly[(meth)acrylic acid] or its alkali metal salts, or (meth)acrylic acid copolymers or their alkali metal salts, mixtures of phosphate and fluoride salts, or sodium silicate. The post-treatment process materials can also comprise unsaturated double bonds to enhance adhesion between the treated surface and the overlying infrared radiation exposed regions. Such unsaturated double bonds can be provided in low molecular weight materials or they can be present within side chains of polymers. Useful post-treatment processes include dipping the substrate with rinsing, dipping the substrate without rinsing, and various coating techniques such as extrusion coating.

An anodized aluminum-containing substrate can be treated with an alkaline or acidic pore-widening solution to provide an anodic oxide layer containing columnar pores. In some embodiments, the treated aluminum-containing substrate can comprise a hydrophilic layer disposed directly on a grained, anodized, and post-treated aluminum-containing support, and such hydrophilic layer can comprise a non-crosslinked hydrophilic polymer having carboxylic acid side chains.

The thickness of an aluminum-containing substrate can be varied but, should be sufficient to sustain the wear from printing and thin enough to be wrapped around a printing form. Useful embodiments include a treated aluminum foil having a thickness of at least 100 m and up to and including 700 m. The backside (non-imaging side) of the aluminum-containing substrate can be coated with antistatic agents, a slipping layer, or a matte layer to improve handling and “feel” of the precursor.

The aluminum-containing substrate can be formed as a continuous roll (or continuous web) of sheet material that is suitably coated with an infrared radiation-sensitive image-recording layer formulation and optionally a protective layer formulation, followed by slitting or cutting (or both) to size to provide individual lithographic printing plate precursors having a shape or form having four right-angled corners (thus, typically in a square or rectangular shape or form). Typically, the cut individual precursors have a planar or generally flat rectangular shape.

Infrared Radiation-Sensitive Image-Recording Layer:

The infrared radiation-sensitive recording layer composition (and infrared radiation-sensitive image-recording layer prepared therefrom) according to the present invention is designed to be “negative-working” as that term is known in the lithographic art. In addition, the infrared radiation-sensitive image-recording layer can provide on-press developability to the lithographic printing plate precursor, for example to enable processing using a fountain solution, a lithographic printing ink, or a combination of the two.

The infrared radiation-sensitive image-recording layer used in the practice of the present invention comprises a) one or more free radically polymerizable components, each of which contains one or more free radically polymerizable groups that can be polymerized using free radical initiation. In some embodiments, at least two free radically polymerizable components, having the same or different numbers of free radically polymerizable groups in each molecule, are present. Thus, useful free radically polymerizable components can contain one or more free radical polymerizable monomers or oligomers having one or more polymerizable ethylenically unsaturated groups (for example, two or more of such groups). Similarly, crosslinkable polymers having such free radically polymerizable groups can also be used. Oligomers or prepolymers, such as urethane acrylates and methacrylates, epoxide acrylates and methacrylates, polyester acrylates and methacrylates, polyether acrylates and methacrylates, and unsaturated polyester resins can be used. In some embodiments, the free radically polymerizable component comprises carboxyl groups.

It is possible for one or more free radically polymerizable components to have large enough molecular weight or to have sufficient polymerizable groups to provide a crosslinkable polymer matrix that functions as a “polymeric binder” for other components in the infrared radiation-sensitive image-recording layer. In such embodiments, a distinct non-free radically polymerizable polymer material (described below) is not necessary but can still be present.

Free radically polymerizable components include urea urethane (meth)acrylates or urethane (meth)acrylates having multiple (two or more) polymerizable groups. Mixtures of such compounds can be used, each compound having two or more unsaturated polymerizable groups, and some of the compounds having three, four, or more unsaturated polymerizable groups. For example, a free radically polymerizable component can be prepared by reacting DESMODUR® N100 aliphatic polyisocyanate resin based on hexamethylene diisocyanate (Bayer Corp., Milford, Conn.) with hydroxyethyl acrylate and pentaerythritol triacrylate. Useful free radically polymerizable compounds include NK Ester A-DPH (dipentaerythritol hexaacrylate) that is available from Kowa American, and Sartomer 399 (dipentaerythritol pentaacrylate), Sartomer 355 (di-trimethylolpropane tetraacrylate), Sartomer 295 (pentaerythritol tetraacrylate), and Sartomer 415 [ethoxylated (20)trimethylolpropane triacrylate] that are available from Sartomer Company, Inc.

Numerous other free radically polymerizable components are known in the art and are described in considerable literature including Photoreactive Polymers: The Science and Technology of Resists, A Reiser, Wiley, New York, 1989, pp. 102-177, by B. M. Monroe in Radiation Curing: Science and Technology, S. P. Pappas, Ed., Plenum, New York, 1992, pp. 399-440, and in “Polymer Imaging” by A. B. Cohen and P. Walker, in Imaging Processes and Material, J. M. Sturge et al. (Eds.), Van Nostrand Reinhold, New York, 1989, pp. 226-262. For example, useful free radically polymerizable components are also described in EP 1,182,033A1 (Fujimaki et al.), beginning with paragraph [0170], and in U.S. Pat. No. 6,309,792 (Hauck et al.), U.S. Pat. No. 6,569,603 (Furukawa), and U.S. Pat. No. 6,893,797 (Munnelly et al.) the disclosures of all of which are incorporated herein by reference. Other useful free radically polymerizable components include those described in U.S. Patent Application Publication 2009/0142695 (Baumann et al.), which radically polymerizable components include 1H-tetrazole groups, and the disclosure of which publication is incorporated herein by reference.

The one or more a) free radically polymerizable components are generally present in an amount of at least 10 weight % or of at least 20 weight %, and up to and including 50 weight %, or up to and including 70 weight %, all based on the total dry coverage of the infrared radiation-sensitive image-recording layer.

In addition, the infrared radiation-sensitive image-recording layer comprises b) one or more infrared radiation absorbers to provide desired infrared radiation sensitivity or to convert radiation to heat, or both. Useful infrared radiation absorbers can be pigments or infrared radiation absorbing dyes. Suitable dyes are those described in for example, U.S. Pat. No. 5,208,135 (Patel et al.), U.S. Pat. No. 6,153,356 (Urano et al.), U.S. Pat. No. 6,309,792 (Hauck et al.), U.S. Pat. No. 6,569,603 (Furukawa), U.S. Pat. No. 6,797,449 (Nakamura et al.), U.S. Pat. No. 7,018,775 (Tao), U.S. Pat. No. 7,368,215 (Munnelly et al.), U.S. Pat. No. 8,632,941 (Balbinot et al.), and U.S. Patent Application Publication 2007/056457 (Iwai et al.), the disclosures of all of which are incorporated herein by reference. In some infrared radiation-sensitive embodiments, it is desirable that at least one b) infrared radiation absorber in the infrared radiation-sensitive imagable layer is a cyanine dye comprising a suitable cationic cyanine chromophore and a tetraarylborate anion such as a tetraphenylborate anion. Examples of such dyes include those described in United States Patent Application Publication 2011/003123 (Simpson et al.), the disclosure of which is incorporated herein by reference.

In addition to low molecular weight IR-absorbing dyes, IR dye chromophores bonded to polymers can be used as well. Moreover, IR dye cations can be used as well, that is, the cation is the IR absorbing portion of the dye salt that ionically interacts with a polymer comprising carboxy, sulfo, phospho, or phosphono groups in the side chains.

The total amount of one or more b) infrared radiation absorbers is at least 0.5 weight % or at least 1 weight %, and up to and including 15 weight %, or up to and including 30 weight %, based on the total dry coverage of the infrared radiation-sensitive image-recording layer.

Moreover, the present invention utilizes c) an initiator composition that is present in the infrared radiation-sensitive image-recording layer. Such c) initiator compositions can include one or more acid generators such as organohalogen compounds, for example trihaloallyl compounds; halomethyl triazines; bis(trihalomethyl) triazines; and onium salts such as iodonium salts, sulfonium salts, diazonium salts, phosphonium salts, and ammonium salts, many of which are known in the art. For example, representative compounds other than onium salts are described for example in [0087] of U.S. Patent Application Publication 2005/0170282 (Inno et al., US '282), the disclosure of which is incorporated herein by reference including the numerous cited publications describing such compounds.

Useful onium salts are described for example from [0103] to [0109] of the cited US '282. For example, useful onium salts comprise least one onium cation in the molecule, and a suitable anion. Examples of the onium salts include triphenylsulfonium, diphenyliodonium, diphenyldiazonium, compounds and derivatives thereof that are obtained by introducing one or more substituents into the benzene ring of these compounds. Suitable substituents include but are not limited to, alkyl, alkoxy, alkoxycarbonyl, acyl, acyloxy, chloro, bromo, fluoro and nitro groups.

Examples of anions in onium salts include but are not limited to, halogen anions, ClO₄⁻, PF₆⁻, BF₄⁻, SbF₆⁻, CH₃SO₃⁻, CF₃SO₃⁻, C₆H₅SO₃⁻, CH₃C₆H₄SO₃⁻, HOC₆H₄SO₃⁻, ClC₆H₄SO₃⁻, and boron anions as described for example in U.S. Pat. No. 7,524,614 (Tao et al.), the disclosure of which is incorporated herein by reference.

Useful onium salts can be polyvalent onium salts having at least two onium ions in the molecule that are bonded through a covalent bond. Among polyvalent onium salts, those having at least two onium ions in the molecule are useful and those having a sulfonium or iodonium cation in the molecule are useful.

Furthermore, the onium salts described in paragraphs [0033] to [0038] of the specification of Japanese Patent Publication 2002-082429 [or U.S. Patent Application Publication 2002-0051934 (Ippei et al.), the disclosure of which is incorporated herein by reference] or the iodonium borate complexes described in U.S. Pat. No. 7,524,614 (noted above), can also be used in the present invention.

In some embodiments, the onium salts can include an acid-generating cation as described above, such as a diaryliodonium cation, and a tetraaryl borate anion for example a tetraphenyl borate anion.

In some embodiments, a combination of acid-generators can be used in the c) initiator composition, for example as a combination of compounds described as Compounds A and Compounds B in U.S. Patent Application Publication 2017/0217149 (Hayashi et al.), the disclosure of which is incorporated herein by reference.

Since the c) initiator composition can have multiple components it would be readily apparent to one skilled in the art as to the useful amount(s) of the various components of the c) initiator composition.

The infrared radiation-sensitive image-recording layer is can optionally comprise one or more suitable co-initiators, chain transfer agents, antioxidants, or stabilizers to prevent or moderate undesired radical reactions. Suitable antioxidants and inhibitors for this purpose are described, for example in [0144] to [0149] of EP 2,735,903B1 (Werner et al.) and in Cols. 7-9 of U.S. Pat. No. 7,189,494 (Munnelly et al.), the disclosure of which is incorporated herein by reference (corresponding to WO2006127313).

An essential feature of the infrared radiation-sensitive image-recording layer is the d) one or more color-forming compounds (for example, singly or a combination of two or more) as described below; and e) one or more compounds (for example, singly or a combination of two or more of such compounds), each being represented by Structure (P) described below.

Useful d) color-forming compounds are compounds that are colorless or nearly colorless in the neutral form and switch to a colored form when protonated. Many leuco dyes are known for this purpose including those described in for example, in [0209] to [0222] of EP 3,418,332A2 (Inasaki et al., corresponding to U.S. Patent Application Publication 2018/0356730, the disclosure of which is incorporated herein by reference), and in [0044] to [0046] of EP 2,018,365B1 (Nguyen et al., corresponding to U.S. Pat. No. 7,910,768, the disclosure of which is incorporated herein by reference). From current investigation, only a few leuco dyes have been identified that fulfil the specific requirements of a strong initial printout image.

For example, in some embodiments, at least one of the d) one or more color-forming compounds comprises a lactone substructure.

More particularly, useful d) one or more color-forming compounds can be represented by one or more of the following Structure (C1) and Structure (C2):

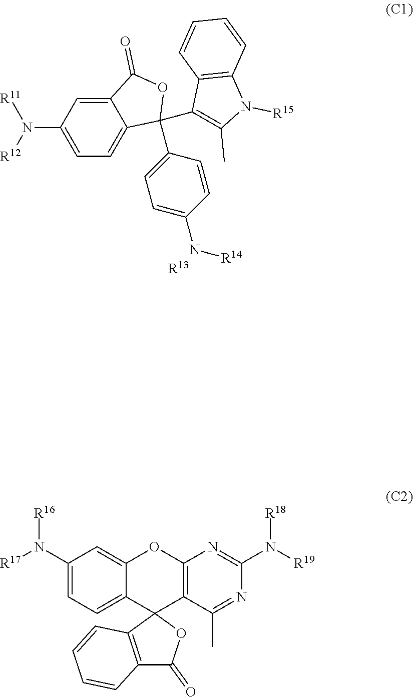

wherein R¹¹ through R¹⁹ are independently hydrogen, unsubstituted or substituted alkyl groups, or unsubstituted or substituted aryl groups. Such substituted or unsubstituted alkyl groups can have 1 to 20 carbon atoms, and possibly one or more substituents can include but are not limited to halogen, alkyl, aryl, alkoxy, and phenoxy groups. Useful substituted or unsubstituted aryl groups can be carbocyclic aromatic rings or heterocyclic aromatic rings, and such groups can have two or more fused rings. Useful substituents for the aryl rings can include but are not limited to, those described above for the alkyl groups. However, skilled chemists could design other useful d) color-forming compounds using this teaching about Structures (C1) and (C2) as guidance.

As noted above, mixtures of two or more of such d) color-forming compounds can be present if desired, in any desired molar ratio.

However, at least one of the d) color-forming compounds present in the infrared radiation-sensitive image-recording layer is not a compound represented by the following Structure (C′):

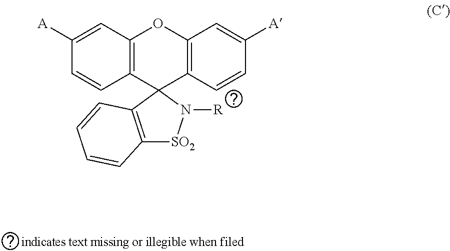

wherein A and A′ are the same or different group represented by the following Structure (AA′):

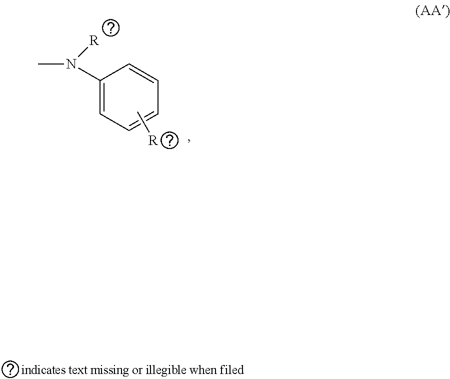

R⁴ is an unsubstituted alkyl group for example having 1 to 6 carbon atom s, R⁵ is an unsubstituted alkyl group for example having 1 to 6 carbon atoms, and R⁶ is a halogen or an alkyl sulfonyl group for example having 1 to 6 carbon atoms. Compounds that fall within Structure (C′) are described for example in EP 2,018,365B1 (Nguyen et al.).

For example, in some embodiments, at least one of the d) one or more color-forming compounds is not a compound represented by one of the following Structures (X) and (Y):

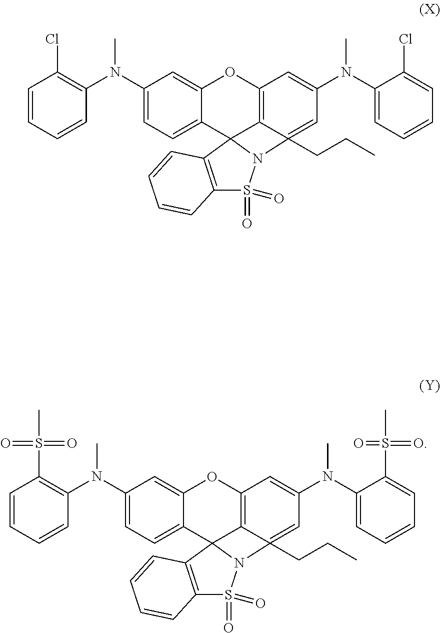

The infrared radiation-sensitive image-recording layer also includes e) one or more compounds, each of which is represented by the following Structure (P):

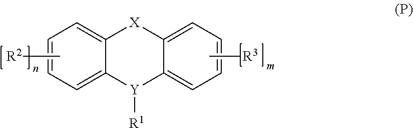

wherein:

X is one of the divalent groups —O—, —S—, —NH—, or —CH₂—, and desirably, X is —S— or —NH—.

Y is one or the trivalent groups >N— or >CH—, and desirably, it is >N—.

R¹ is hydrogen or a substituted or unsubstituted alkyl group, generally having from 1 to 20 carbon atoms in the unsubstituted form. When the alkyl group is substituted, it can have one or more substituents as allowed by its valence, as long as such substituents do not adversely affect the function of the d) printout composition in providing a suitable, stable printout image as defined herein.

R² and R³ are independently halo (fluoro, chloro, bromo, iodo), thioalkyl (that is, —S-alkyl, having 1 to 20 carbon atoms), thiophenyl (that is —S— phenyl), alkoxy (that is, —O-alkyl, having 1 to 20 carbon atoms), phenoxy (that is, —O-phenyl), alkyl (having 1 to 20 carbon atoms), phenyl, thioacetyl [that is, —C(═S)CH₃], or acetyl [that is, —C(═O)CH₃], groups. Where chemically possible, such groups can be substituted with one or more substituents as long as they do not adversely affect the function of the d) printout composition in providing a suitable, stable printout image as defined herein. It is particularly useful that R² and R³ are independently a chloro, thioalkyl (having 1 or 2 carbon atoms), or acetyl, group.

Moreover, in Structure (P), m and n are independently 0 or an integer of from 1 to 4. Typically, m and n are independently 0, 1, or 2. Each of m and n can be zero; m can be zero and n can be 1 or 2; or m can be 1 and n can be 1 or 2.

As noted above, mixtures of two or more of the e compounds represented by Structure (P) can be used if desired.

The total amount of the d) one or more color-forming compounds in the infrared radiation-sensitive image-recording layer is generally at least 1 weight %, or at least 2 weight %, and up to and including 8 weight % or up to and including 10 weight % (generic maximum), all based on the total dry coverage of the infrared radiation-sensitive image-recording layer.

In addition, the e) one or more compounds, each represented by Structure (P) can be present in an amount that suitably effects optimal printout image and stability of that printout image. For example, the molar ratio of d) one or more color-forming compounds to e) one or more compounds represented by Structure (P) can be at least 1.1:1.0 and up to and including 50:1.0, or more likely at least 1.1:1.0 and up to and including 30:1.0.

It is optional but desirable in some embodiments that the infrared radiation-sensitive image-recording layer further comprise a f) non-free radically polymerizable polymeric material (or polymeric binder) that does not have any functional groups that, if present, would make the polymeric material capable of free radical polymerization. Thus, such f) non-free radically polymerizable polymeric materials are different from the a) one or more free radically polymerizable components described above, and they are different materials from all of the b), c), d), and e) components described above.

Such f) non-free radically polymerizable polymeric materials can be selected from polymeric binder materials known in the art including polymers comprising recurring units having side chains comprising polyalkylene oxide segments such as those described in for example, U.S. Pat. No. 6,899,994 (Huang et al.) the disclosure of which is incorporated herein by reference. Other useful polymeric binders comprise two or more types of recurring units having different side chains comprising polyalkylene oxide segments as described in for example WO Publication 2015-156065 (Kamiya et al.). Some of such polymeric binders can further comprise recurring units having pendant cyano groups as those described in for example U.S. Pat. No. 7,261,998 (Hayashi et al.) the disclosure of which is incorporated herein by reference.

Such f) polymeric binders also can have a backbone comprising multiple (at least two) urethane moieties as well as pendant groups comprising the polyalkylenes oxide segments.

Some useful f) non-free radically polymerizable polymeric materials, can be present in particulate form, that is, in the form of discrete particles (non-agglomerated particles). Such discrete particles can have an average particle size of at least 10 nm and up to and including 1500 nm, or typically of at least 80 nm and up to and including 600 nm, and that are generally distributed uniformly within the infrared radiation-sensitive image-recoding layer. Some of these materials can be present in particulate form and have an average particle size of at least 50 nm and up to and including 400 nm. Average particle size can be determined using various known methods and nanoparticle measuring equipment, including measuring the particles in electron scanning microscope images and averaging a set number of measurements.

In some embodiments, the f) non-free radically polymerizable polymeric material can be present in the form of particles having an average particle size that is less than the average dry thickness (t) of the infrared radiation-sensitive image-recording layer. The average dry thickness (t) in micrometers (μm) is calculated by the following Equation:

t=w/r

wherein w is the dry coating coverage of the infrared radiation-sensitive image-recording layer in g/m² and r is 1 g/cm³.

When present, the f) non-free radically polymerizable polymeric material(s) can be present in an amount of at least 10 weight %, or at least 20 weight %, and up to and including 50 weight %, or up to and including 70 weight %, based on the total dry coverage of the infrared radiation-sensitive image-recording layer.

Useful f) non-free radically polymerizable polymeric materials generally have a weight average molecular weight (Mw) of at least 2,000, or at least 20,000, and up to and including 300,000 or up to and including 500,000, as determined by Gel Permeation Chromatography (polystyrene standard).

Useful f) non-free radically polymerizable polymeric materials can be obtained from various commercial sources or they can be prepared using known procedures and starting materials, as described for example in publications described above.

The infrared radiation-sensitive image-recording layer can include crosslinked polymer particles as additional optional addenda, such materials having an average particle size of at least 2 μm, or of at least 4 μm, and up to and including 20 μm as described for example in U.S. Pat. No. 9,366,962 (Hayakawa et al.), U.S. Pat. No. 8,383,319 (Huang et al.) and U.S. Pat. No. 8,105,751 (Endo et al), the disclosures of all of which are incorporated herein by reference. Such crosslinked polymeric particles can be present only in the infrared radiation-sensitive image-recording layer, the hydrophilic protective layer when present (described below), or in both the infrared radiation-sensitive image-recording layer and the hydrophilic protective layer when present.

The infrared radiation-sensitive image-recording layer can also include a variety of other optional addenda including but not limited to, dispersing agents, humectants, biocides, plasticizers, surfactants for coatability or other properties, viscosity builders, pH adjusters, drying agents, defoamers, development aids, rheology modifiers, or combinations thereof, or any other addenda commonly used in the lithographic art, in conventional amounts. The infrared radiation-sensitive image-recording layer can also include a phosphate (meth)acrylate having a molecular weight generally greater than 250 as described in U.S. Pat. No. 7,429,445 (Munnelly et al.) the disclosure of which is incorporated herein by reference.

The useful dry coverage of the infrared radiation-sensitive image-recording layer is described below.

Hydrophilic Protective Layer:

While in some embodiments of the present invention, the infrared radiation-sensitive image-recording layer is the outermost layer with no layers disposed thereon, it is possible that the precursors according to this invention can be designed with a hydrophilic protective layer (also known in the art as a hydrophilic overcoat, oxygen-barrier layer, or topcoat) disposed directly on the single infrared radiation-sensitive image-recording layer (with no intermediate layers between these two layers).

When present, this hydrophilic protective layer is generally the outermost layer of the precursor and thus, when multiple precursors are stacked one on top of the other, the hydrophilic protective layer of one precursor can be in contact with the backside of the substrate of the precursor immediately above it, where no interleaving paper is present.

Such hydrophilic protective layers can comprise one or more film-forming water-soluble polymeric binders in an amount of at least 60 weight % and up to and including 100 weight %, based on the total dry weight of the hydrophilic protective layer. Such film-forming water-soluble (or hydrophilic) polymeric binders can include a modified or unmodified poly(vinyl alcohol) having a saponification degree of at least 30%, or a degree of at least 75%, or a degree of at least 90%, and a degree of up to and including 99.9%.

Further, one or more acid-modified poly(vinyl alcohol)s can be used as film-forming water-soluble (or hydrophilic) polymeric binders in the hydrophilic protective layer. For example, at least one poly(vinyl alcohol) can be modified with an acid group selected from the group consisting of carboxylic acid, sulfonic acid, sulfuric acid ester, phosphonic acid, and phosphoric acid ester groups. Examples of useful modified poly(vinyl alcohol) materials include but are not limited to, sulfonic acid-modified poly(vinyl alcohol), carboxylic acid-modified poly(vinyl alcohol), and quaternary ammonium salt-modified poly(vinyl alcohol), glycol-modified poly(vinyl alcohol), or combinations thereof.

The optional hydrophilic overcoat can also include crosslinked polymer particles having an average particle size of at least 2 μm and as noted above.

When present, the hydrophilic protective layer is provided as a hydrophilic protective layer formation and dried to provide a dry coating coverage of at least 0.1 g/m² and up to but less than 4 g/m², and typically at a dry coating coverage of at least 0.15 g/m² and up to and including 2.5 g/m². In some embodiments, the dry coating coverage is as low as 0.1 g/m² and up to and including 1.5 g/m² or at least 0.1 g/m² and up to and including 0.9 g/m², such that the hydrophilic protective layer is relatively thin for easy removal during off-press development or on-press development.

The hydrophilic protective layer can optionally comprise organic wax particles dispersed, generally uniformly, within the one or more film-forming water-soluble (or hydrophilic) polymeric binders as described for example in U.S. Patent Application Publication 2013/0323643 (Balbinot et al.) the disclosure of which is incorporated herein by reference.

Preparing Lithographic Printing Plate Precursors:

The lithographic printing plate precursors according to the present invention can be provided in the following manner. An infrared radiation-sensitive image-recording layer formulation comprising components a), b), c), d), and e), and optionally f), described above can be applied to a hydrophilic surface of a suitable aluminum-containing substrate, usually in the form of a continuous web, as described above using any suitable equipment and procedure, such as spin coating, knife coating, gravure coating, die coating, slot coating, bar coating, wire rod coating, roller coating, or extrusion hopper coating. Such formulation can also be applied by spraying onto a suitable substrate. Typically, once the infrared radiation-sensitive image-recording layer formulation is applied at a suitable wet coverage, it is dried in a suitable manner known in the art to provide a desired dry coverage as noted below, thereby providing an infrared radiation-sensitive continuous web or an infrared radiation-sensitive continuous article.

As noted above, before the infrared radiation-sensitive image-recording layer formulation is applied, the aluminum-containing substrate (that is, a continuous roll or web) has been electrochemically grained and anodized as described above to provide a suitable hydrophilic anodic (aluminum oxide) layer on the outer surface of the aluminum-containing support, and the anodized surface usually can be post-treated with a hydrophilic polymer solution as described above. The conditions and results of these operations are well known in the art as described above.

The manufacturing methods typically include mixing the various components needed for the infrared radiation-sensitive image-recording layer in a suitable organic solvent or mixtures thereof with or without water [such as methyl ethyl ketone (2-butanone), methanol, ethanol, 1-methoxy-2-propanol, 2-methoxypropanol, iso-propyl alcohol, acetone, γ-butyrolactone, n-propanol, tetrahydrofuran, and others readily known in the art, as well as mixtures thereof], applying the resulting infrared radiation-sensitive image-recording layer formulation to a continuous substrate web, and removing the solvent(s) by evaporation under suitable drying conditions.

After proper drying, the dry coverage of the infrared radiation-sensitive image-recording layer on the aluminum-containing substrate is generally at least 0.1 g/m², or at least 0.4 g/m², and up to and including 2 g/m² or up to and including 4 g/m² but other dry coverage amounts can be used if desired.

As described above, in some embodiments, a suitable aqueous-based hydrophilic protective layer formulation (described above) can be applied to the dried infrared radiation-sensitive image-recording layer using known coating and drying conditions, equipment, and procedures.

In practical manufacturing conditions, the result of these coating operations is a continuous radiation-sensitive web (or roll) of infrared radiation-sensitive lithographic printing plate precursor material having either only a single infrared radiation-sensitive image-recording layer or both a single infrared radiation-sensitive image-recording layer and a hydrophilic protective layer disposed as the outermost layer.

### Imaging (Exposing) Conditions

During use, an infrared radiation-sensitive lithographic printing plate precursor of this invention can be exposed to a suitable source of exposing infrared radiation depending upon the infrared radiation absorber(s) present in the infrared radiation-sensitive image-recording layer. In some embodiments, the lithographic printing plate precursors can be imaged with one or more lasers that emit significant infrared radiation within the range of at least 750 nm and up to and including 1400 nm, or of at least 800 nm and up to and including 1250 nm to create exposed regions and non-exposed regions in the infrared radiation-sensitive image-recording layer. Such infrared radiation-emitting lasers can be used for such imaging in response to digital information supplied by a computing device or other source of digital information. The laser imaging can be digitally controlled in a suitable manner known in the art.

Thus, imaging can be carried out using imaging or exposing infrared radiation from an infrared radiation-generating laser (or array of such lasers). Imaging also can be carried out using imaging radiation at multiple infrared (or near-IR) wavelengths at the same time if desired. The laser(s) used to expose the precursor is usually a diode laser(s), because of the reliability and low maintenance of diode laser systems, but other lasers such as gas or solid-state lasers can also be used. The combination of power, intensity and exposure time for infrared radiation imaging would be readily apparent to one skilled in the art.

The infrared imaging apparatus can be configured as a flatbed recorder or as a drum recorder, with the infrared radiation-sensitive lithographic printing plate precursor mounted to the interior or exterior cylindrical surface of the drum. An example of useful imaging apparatus is available as models of KODAK® Trendsetter platesetters (Eastman Kodak Company) and NEC AMZISetter X-series (NEC Corporation, Japan) that contain laser diodes that emit radiation at a wavelength of about 830 nm. Other suitable imaging apparatus includes the Screen PlateRite 4300 series or 8600 series platesetters (available from Screen USA, Chicago, Ill.) or thermal CTP platesetters from Panasonic Corporation (Japan) that operates at a wavelength of 810 nm.

It can be desirable to include a means for reducing or removing ozone in the environment of the laser imaging if the infrared radiation-sensitive image-recording layer is sensitive to the presence of ozone. Useful means and system for doing this is described for example in copending and commonly assigned U.S. Application Publication 2019/0022995 (Igarashi et al.), the disclosure of which is incorporated herein by reference.

When an infrared radiation imaging source is used, imaging intensities can be at least 30 mJ/cm² and up to and including 500 mJ/cm² and typically at least 50 mJ/cm² and up to and including 300 mJ/cm² depending upon the sensitivity of the infrared radiation-sensitive image-recording layer.

### Processing (Development) and Printing

After imagewise exposing as described above, the exposed infrared radiation-sensitive lithographic printing plate precursors having exposed regions and non-exposed regions in the infrared radiation-sensitive image-recording layer can be processed off-press or on-press to remove the non-exposed regions (and any hydrophilic protective layer over such regions). After this processing, and during lithographic printing, the revealed hydrophilic substrate surface repels inks while the remaining exposed regions accept lithographic printing ink.

Off-Press Development and Printing:

Processing can be carried out off-press using any suitable developer in one or more successive applications (treatments or developing steps) of the same or different processing solution (developer). Such one or more successive processing treatments can be carried out for a time sufficient to remove the non-exposed regions of the infrared radiation-sensitive image-recording layer to reveal the outermost hydrophilic surface of the inventive substrate, but not long enough to remove significant amounts of the exposed regions that have been hardened in the same layer.

Prior to such off-press processing, the exposed precursors can be subjected to a “pre-heating” process to further harden the exposed regions in the infrared radiation-sensitive image-recording layer. Such optional pre-heating can be carried out using any known process and equipment generally at a temperature of at least 60° C. and up to and including 180° C.

Following this optional pre-heating, or in place of the pre-heating, the exposed precursor can be washed (rinsed) to remove any hydrophilic overcoat that is present. Such optional washing (or rinsing) can be carried out using any suitable aqueous solution (such as water or an aqueous solution of a surfactant) at a suitable temperature and for a suitable time that would be readily apparent to one skilled in the art.

Useful developers can be ordinary water or formulated aqueous solutions. The formulated developers can comprise one or more components selected from surfactants, organic solvents, alkali agents, and surface protective agents. For example, useful organic solvents include the reaction products of phenol with ethylene oxide and propylene oxide [such as ethylene glycol phenyl ether (phenoxyethanol)], benzyl alcohol, esters of ethylene glycol and of propylene glycol with acids having 6 or less carbon atoms, and ethers of ethylene glycol, diethylene glycol, and of propylene glycol with alkyl groups having 6 or less carbon atoms, such as 2-ethylethanol and 2-butoxyethanol.

In some instances, an aqueous processing solution can be used off-press to both develop the imaged precursor by removing the non-exposed regions and also to provide a protective layer or coating over the entire imaged and developed (processed) precursor printing surface. In this embodiment the aqueous solution behaves somewhat like a gum that is capable of protecting (or “gumming”) the lithographic image on the lithographic printing plate against contamination or damage (for example, from oxidation, fingerprints, dust, or scratches).

After the described off-press processing and optional drying, the resulting lithographic printing plate can be mounted onto a printing press without any contact with additional solutions or liquids. It is optional to further bake the lithographic printing plate with or without blanket or flood-wise exposure to UV or visible radiation.

Printing can be carried out by applying a lithographic printing ink and fountain solution to the printing surface of the lithographic printing plate in a suitable manner. The fountain solution is taken up by the hydrophilic surface of the inventive substrate revealed by the exposing and processing steps, and the lithographic ink is taken up by the remaining (exposed) regions of the infrared radiation-sensitive image-recording layer. The lithographic ink is then transferred to a suitable receiving material (such as cloth, paper, metal, glass, or plastic) to provide a desired impression of the image thereon. If desired, an intermediate “blanket” roller can be used to transfer the lithographic ink from the lithographic printing plate to the receiving material (for example, sheets of paper).

On-Press Development and Printing:

Alternatively, the negative-working lithographic printing plate precursors of the present invention are on-press developable using a lithographic printing ink, a fountain solution, or a combination of a lithographic printing ink and a fountain solution. In such embodiments, an imaged (exposed) infrared radiation-sensitive lithographic printing plate precursor according to the present invention is mounted onto a printing press and the printing operation is begun. The non-exposed regions in the infrared radiation-sensitive image-recording layer are removed by a suitable fountain solution, lithographic printing ink, or a combination of both, when the initial printed impressions are made. Typical ingredients of aqueous fountain solutions include pH buffers, desensitizing agents, surfactants and wetting agents, humectants, low boiling solvents, biocides, antifoaming agents, and sequestering agents. A representative example of a fountain solution is Varn Litho Etch 142W+Varn PAR (alcohol sub) (available from Varn International, Addison, Ill.).

In a typical printing press startup with a sheet-fed printing machine, the dampening roller is engaged first and supplies fountain solution to the mounted imaged precursor to swell the exposed infrared radiation-sensitive image-recording layer at least in the non-exposed regions. After a few revolutions the inking rollers are engaged and they supply lithographic printing ink(s) to cover the entire printing surface of the lithographic printing plates. Typically, within 5 to 20 revolutions after the inking roller engagement, printing sheets are supplied to remove the non-exposed regions of the infrared radiation-sensitive image-recording layer from the lithographic printing plate as well as materials on a blanket cylinder if present, using the formed ink-fountain solution emulsion.

On-press developability of infrared radiation exposed lithographic printing precursors is particularly useful when the precursor comprises one or more polymeric binder materials (whether free radically polymerizable or not) in an infrared radiation-sensitive image-recording layer, at least one of which polymeric binders is present as particles having an average diameter of at least 50 nm and up to and including 400 nm.

The present invention provides at least the following embodiments and combinations thereof, but other combinations of features are considered to be within the present invention as a skilled artisan would appreciate from the teaching of this disclosure:

1. A lithographic printing plate precursor comprising an aluminum-containing substrate, and an infrared radiation-sensitive image-recording layer disposed on the aluminum-containing substrate,

the infrared radiation-sensitive image-recording layer comprising:
a) one or more free radically polymerizable components;
b) one or more infrared radiation absorbers;
c) an initiator composition;
d) one or more color-forming compounds;
e) one or more compounds, each being represented by the following Structure (P):

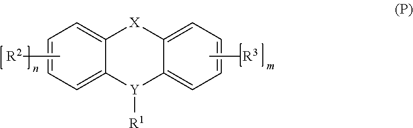

wherein X is the group —O—, —S—, —NH—, or —CH₂—, Y is the group >N— or >CH—, R¹ is hydrogen or a substituted or unsubstituted alkyl, R² and R³ are independently halo, thioalkyl, thiophenyl, alkoxy, phenoxy, alkyl, phenyl, thioacetyl, or acetyl, groups, and m and n are independently 0 or an integer of from 1 to 4; and
f) optionally, a non-free radically polymerizable polymeric material different from the a), b), c), d), and e) components defined above,

wherein the infrared radiation-sensitive image-recording layer, upon exposure to infrared radiation to provide exposed regions and non-exposed regions, exhibits a color contrast between the exposed regions and non-exposed regions of a ΔE greater than 8, and wherein a ΔE of at least 5 is maintained between the exposed regions and the non-exposed regions after storage of the exposed image-recording layer under white light for at least one hour.

2. The lithographic printing plate precursor of embodiment 1, provided that at least one of the d) one or more color-forming compounds is not a compound represented by the following Structure (C′):

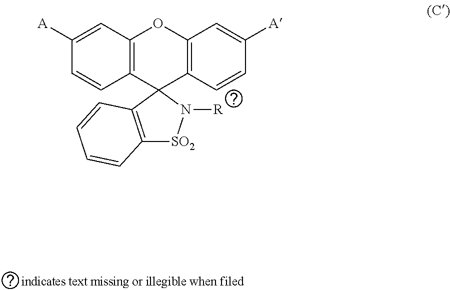

wherein A and A′ are the same or different group represented by the following Structure (AA′):

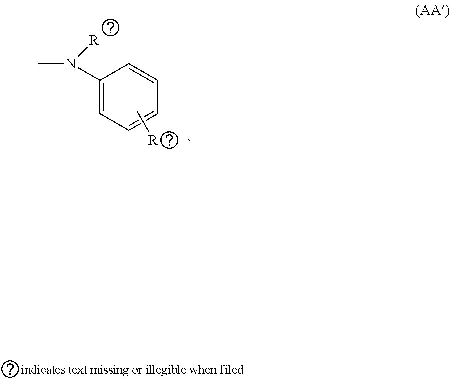

R⁴ is an unsubstituted alkyl group, R⁵ is an unsubstituted alkyl group, and R⁶ is a halogen or an alkyl sulfonyl group.

3. The lithographic printing plate precursor of embodiment 1 or 2, provided that at least one of the d) one or more color-forming compounds is not a compound represented by one of the following Structures (X) and (Y):

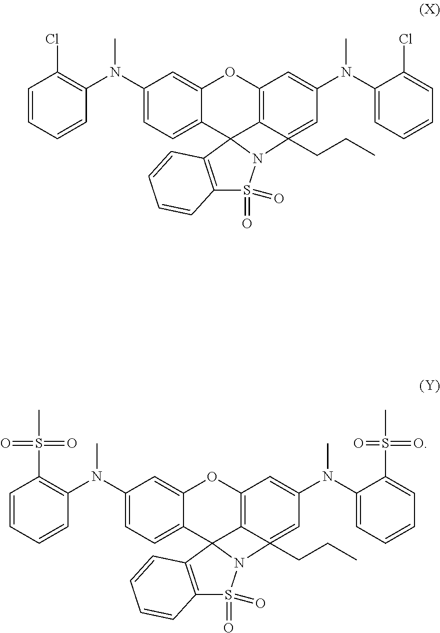

4. The lithographic printing plate precursor of any of embodiments 1 to 3, wherein at least one of the d) one or more color-forming compounds comprises a lactone substructure.

5. The lithographic printing plate precursor of any of embodiments 1 to 4, wherein the d) one or more color-forming compounds and the e) one or more compounds represented by Structure (P) are present in the infrared radiation-sensitive image-recording layer at a d) to e) molar ratio of at least 1.1:1 to and including 50:1.

6. The lithographic printing plate precursor of embodiment 5, wherein the d) one or more color-forming compounds are present in the infrared radiation-sensitive image-recording layer in a dry coverage amount of at least 2 weight % and up to and including 10 weight %.

7. The lithographic printing plate precursor of any of embodiments 1 to 6, wherein the f) polymeric material is present in particulate form.

8. The lithographic printing plate precursor of any of embodiments 1 to 7, wherein the infrared radiation-sensitive image-recording layer is the outermost layer.

9. The lithographic printing plate precursor of any of embodiments 1 to 8, that is on-press developable.

10. The lithographic printing plate precursor of any of embodiments 1 to 9, wherein the a) one or more free radically polymerizable components comprise at least two free radically polymerizable components.

11. The lithographic printing plate precursor of any of embodiments 1 to 10, wherein the c) initiator composition comprises a diaryliodonium salt.

12. The lithographic printing plate precursor of any of embodiments 1 to 11, wherein the aluminum-containing substrate comprises an aluminum oxide layer provided by phosphoric acid anodization, and a hydrophilic polymer coating is disposed on the aluminum oxide layer.

13. The lithographic printing plate precursor of any of embodiments 1 to 12, wherein X is —S— or —NH—, and Y is >N—.

14. The lithographic printing plate precursor of any of embodiments 1 to 13, wherein m and n are independently 0, 1, or 2, and R² and R³ are independently a chloro, a thioalkyl having 1 or 2 carbon atoms, or an acetyl, group.

15. The lithographic printing plate precursor of any of embodiments 1 to 14, wherein the d) one or more color-forming compounds are represented by one or both of the following Structures (C1) and (C2):

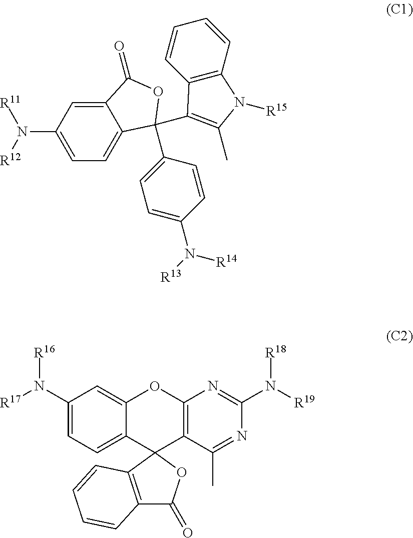

wherein R¹¹ through R¹⁹ are independently hydrogen, unsubstituted or substituted alkyl groups, or unsubstituted or substituted aryl groups.

16. The lithographic printing plate precursor of any of embodiments 1 to 15, wherein the e) one or more compounds represented by Structure (P) are one or more of the following Compounds 1 through 4:

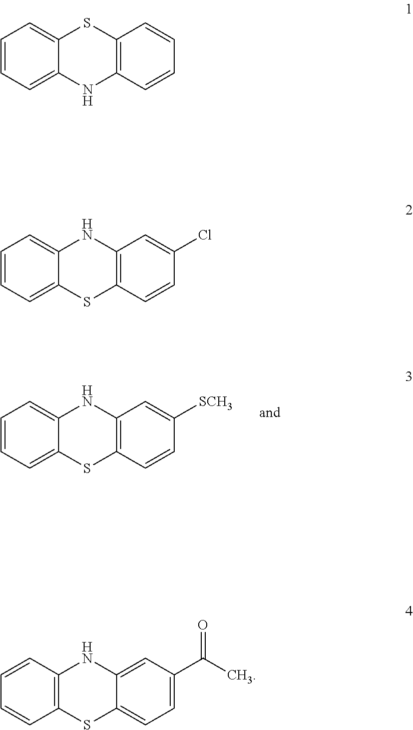 [SMILES: c1ccc2c(c1)Nc1ccccc1S2 ; Clc1ccc2c(c1)Nc1ccccc1S2 ; CSc1ccc2c(c1)Nc1ccccc1S2 ; CC(=O)c1ccc2c(c1)Nc1ccccc1S2]

17. The lithographic printing plate precursor of any of embodiments 1 to 16, wherein the c) initiator composition comprises a tetraaryl borate.

18. A method for providing a lithographic printing plate, comprising:

A) imagewise exposing the lithographic printing plate precursor according to any of embodiments 1 to 17 to infrared radiation, to provide exposed regions and non-exposed regions in the infrared radiation-sensitive image-recording layer, and

B) removing the non-exposed regions in the infrared radiation-sensitive image-recording layer from the aluminum-containing substrate.

19. The method of embodiment 18, comprising removing the non-exposed regions in the infrared radiation-sensitive image-recording layer from the aluminum-containing substrate on-press using a lithographic printing ink, a fountain solution, or a combination of a lithographic printing ink and a fountain solution.

The following examples are provided to further illustrate the practice of the present invention and are not meant to be limiting in any manner. Unless otherwise indicated, the materials used in the examples were obtained from various commercial sources as indicated but other commercial sources may be available.

An aluminum-containing substrate was prepared for the lithographic printing plate precursors in the following manner:

A surface of an aluminum alloy sheet (support) was subjected to an electrolytic roughening treatment using hydrochloric acid to provide an average roughness Ra of 0.5 μm. The resulting grained aluminum sheet was subjected to an anodizing treatment using an aqueous phosphoric acid solution to form an aluminum oxide layer of about 500 nm in dry thickness, followed by a post-treatment application of a poly(acrylic acid) solution, to provide an aluminum-containing substrate.

An infrared radiation-sensitive image recording layer was then applied to the aluminum-containing substrate by coating the infrared radiation-sensitive recording layer formulation having the components shown in the following TABLE I using a bar coater, to provide a dry coating weight of 0.9 g/m² after drying at 50° C. for 60 seconds, and components and their amounts are defined below in TABLE II and TABLE III. In TABLE III, the “examples” are identified as either comparative examples (C-1 through C-15) or inventive examples (I-1 through I-4).

TABLE I

| Component | Amount (grams) |
|---|---|
| Polymer dispersion | 0.675 |
| Hydroxypropyl methyl cellulose | 0.400 |
| Monomer 1 | 0.333 |
| Monomer 2 | 0.167 |
| IR dye 1 | 0.020 |
| Surfactant 1 | 0.045 |
| Iodonium salt 1 | 0.06 |
| 1-Propanol | 2.6 |
| 2-Butanone | 3.5 |
| 1-Methoxy-2-propanol | 0.92 |
| δ-Butyrolactone | 0.10 |
| Water | 1.16 |

TABLE II

| | |
|---|---|
| Polymer | The polymer dispersion was prepared according to Example 10 of EP 1,765,593, |
| dispersion | used as 23.5 weight % polymer in n-propanol/water at 80:20 weight ratio |
| Hydroxypropyl | 5 weight % hydroxypropyl methyl cellulose polymer in water; the polymer is |
| methyl | 30% methoxylated, 10% hydroxyl propoxylated and had a viscosity of 5 mPa-sec |
| cellulose | in a 2 weight % aqueous solution at 20° C. |
| Monomer 1 | Urethane acrylate prepared by reacting DESMODUR ® N100 (from Bayer Corp., |
| | Milford, CT) with hydroxyethyl acrylate and pentaerythritol triacrylate at |
| | approximately 1:1.5:1.5 molar ratio (40 weight % in 2-butanone). |
| Monomer 2 | Ethoxylated (10 EO) Bisphenol A acrylate, 40 weight % in 2-butanone |
| IR dye 1 | 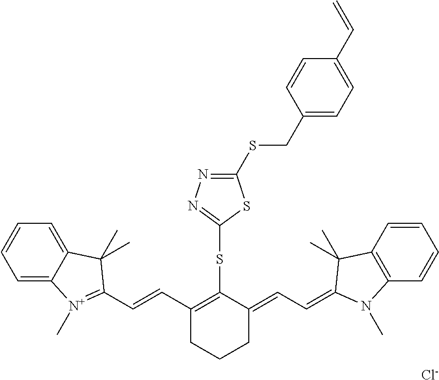 [SMILES: C=Cc1ccc(CSc2nnc(SC3=C(/C=C/C4=[N+](C)c5ccccc5C4(C)C)CCC/C3=C\C=C3\N(C)c4ccccc4C3(C)C)s2)cc1 ; [Cl-]] |
| Surfactant 1 | BYK ® 302 from Byk Chemie, used as a 25 weight % solution in 1-methoxy-2- |
| | propanol |
| Iodonium salt 1 | 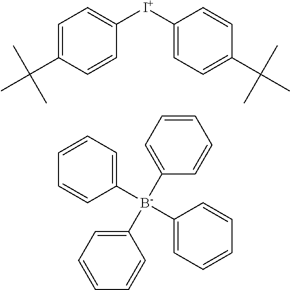 [SMILES: CC(C)(C)c1ccc([I+]c2ccc(C(C)(C)C)cc2)cc1 ; c1ccc([B-](c2ccccc2)(c2ccccc2)c2ccccc2)cc1] |
| Color-forming compound 1 | 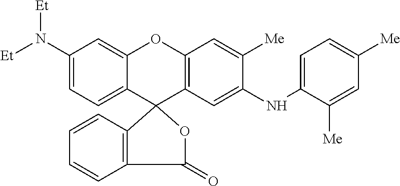 [SMILES: CCN(CC)c1ccc2c(c1)Oc1cc(C)c(Nc3ccc(C)cc3C)cc1C21OC(=O)c2ccccc21] |
| Color-forming compound 2 [Invention d) compound] | 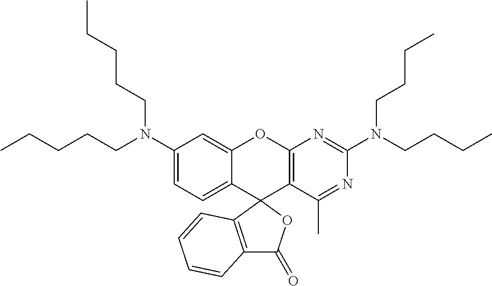 [SMILES: CCCCCN(CCCCC)c1ccc2c(c1)Oc1nc(N(CCCC)CCCC)nc(C)c1C21OC(=O)c2ccccc21] |
| Color-forming compound 3 | 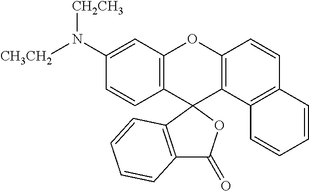 |
| Color-forming compound 4 | 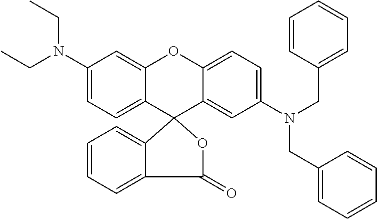 [SMILES: CCN(CC)c1ccc2c(c1)Oc1ccc(N(Cc3ccccc3)Cc3ccccc3)cc1C21OC(=O)c2ccccc21] |
| Color-forming compound 5 | 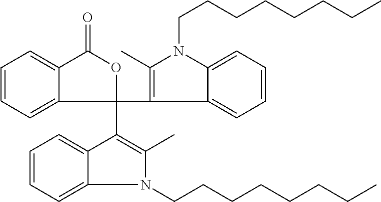 [SMILES: CCCCCCCCn1c(C)c(C2(c3c(C)n(CCCCCCCC)c4ccccc34)OC(=O)c3ccccc32)c2ccccc21] |
| Color-forming compound 6 | 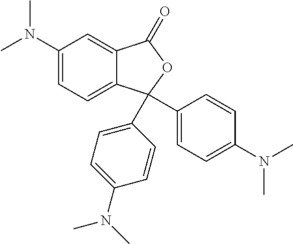 |
| Color-forming compound 7 | 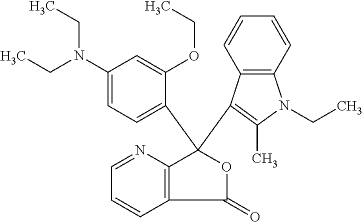 [SMILES: CCOc1cc(N(CC)CC)ccc1C1(c2c(C)n(CC)c3ccccc23)OC(=O)c2cccnc21] |
| Color-forming compound 8 | 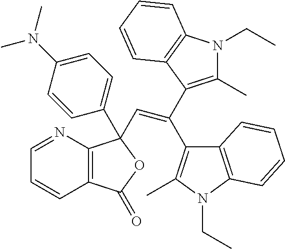 [SMILES: CCn1c(C)c(C(=CC2(c3ccc(N(C)C)cc3)OC(=O)c3cccnc32)c2c(C)n(CC)c3ccccc23)c2ccccc21] |
| Compound 1 | 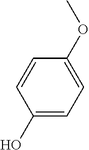 |
| Compound 2 [Invention e) compound] | 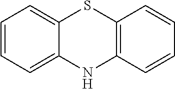 [SMILES: c1ccc2c(c1)Nc1ccccc1S2] |
| Compound 3 [Invention e) compound] | 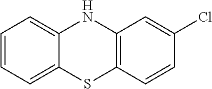 [SMILES: Clc1ccc2c(c1)Nc1ccccc1S2] |
| Compound 4 [Invention e) compound] | 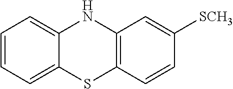 [SMILES: CSc1ccc2c(c1)Nc1ccccc1S2] |
| Compound 5 [Invention e) compound] | 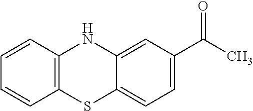 [SMILES: CC(=O)c1ccc2c(c1)Nc1ccccc1S2] |
| Compound 6 | 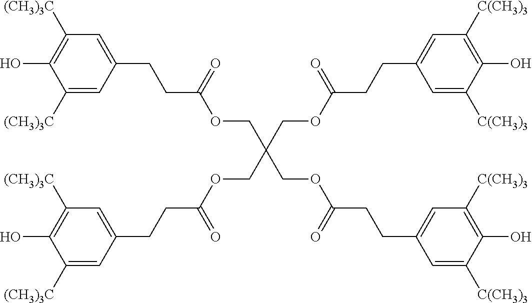 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O] |
| Compound 7 | 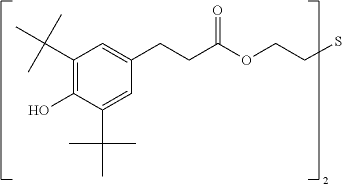 |
| Compound 8 | 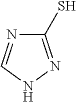 |
| Compound 9 | 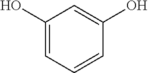 |

TABLE III

| | Color- | Color-forming | | Compound |
|---|---|---|---|---|
| | forming | Compound | | Amount |
| Example | Compound | Amount [grams] | Compound | [grams] |
| C-1 | 1 | 0.025 | None | |
| C-2 | 2 | 0.025 | None | |
| C-3 | 1 | 0.025 | 1 | 0.005 |
| C-4 | 2 | 0.025 | 1 | 0.005 |
| C-5 | 1 | 0.025 | 2 | 0.005 |
| C-6 | 3 | 0.025 | 2 | 0.005 |
| C-7 | 4 | 0.025 | 2 | 0.005 |
| C-8 | 5 | 0.025 | 2 | 0.005 |
| C-9 | 6 | 0.025 | 2 | 0.005 |
| C-10 | 7 | 0.025 | 2 | 0.005 |
| C-11 | 8 | 0.025 | 2 | 0.005 |
| C-12 | 2 | 0.025 | 6 | 0.005 |
| C-13 | 2 | 0.025 | 7 | 0.005 |
| C-14 | 2 | 0.025 | 8 | 0.005 |
| C-15 | 2 | 0.025 | 9 | 0.005 |
| I-1 | 2 | 0.025 | 2 | 0.005 |
| I-2 | 2 | 0.025 | 3 | 0.005 |
| I-3 | 2 | 0.025 | 4 | 0.005 |
| I-4 | 2 | 0.025 | 5 | 0.005 |

TABLE IV

| Example | Print-out | White Light Stability |
|---|---|---|
| C-1 | 0 | 0 |
| C-2 | + | − |
| C-3 | 0 | 0 |
| C-4 | + | 0 |
| C-5 | 0 | 0 |
| C-6 | 0 | 0 |
| C-7 | 0 | 0 |
| C-8 | 0 | 0 |
| C-9 | 0 | 0 |
| C-10 | − | − |
| C-11 | 0 | − |
| C-12 | + | 0 |
| C-13 | + | 0 |
| C-14 | + | − |
| C-15 | + | 0 |
| I-1 | + | + |
| I-2 | + | + |
| I-3 | + | + |
| I-4 | + | + |

The evaluations shown in TABLE IV were obtained as follows:

### Print-Out:

Each of the lithographic printing plate precursors was imagewise exposed using a Trendsetter 800 III Quantum TH 1.7 (available from Eastman Kodak Company) at 120 mJ/cm² to provide exposed regions and non-exposed regions in the IR-sensitive recording layer. For each imagewise exposed lithographic printing plate precursor, the color difference between exposed regions and non-exposed regions was measured by determining the ΔE value, using a Techkon Spectro Dens spectral densitometer, calculating the Euclidean distance of the measured L*a*b values, and given the following qualitative values.

| | |
|---|---|
| + | ΔE > 8 |
| 0 | ΔE = 5 − 8 |
| − | ΔE < 5 |

### White Light Stability:

Each lithographic printing plate precursor was imagewise exposed as described above, and then placed in a light sealed box with a D50 white light source attached in a way that 1000 Lux was measured at the position of the lithographic printing plate precursors. The white light was turned on for exactly one hour. Immediately after the white light was switched off, the ΔE values were determined as described above and given the following qualitative values.

| | |
|---|---|
| + | ΔE > 5 |
| 0 | ΔE = 3 − 5 |
| − | ΔE < 3 |

In addition, it was determined that on-press developability was acceptable for all exposed lithographic printing plate precursors. On-press developability was evaluated by imagewise exposing each lithographic printing plate precursor at 120 mJ/cm² using a Trendsetter 800 III Quantum TH 1.7 (available from Eastman Kodak Company). Each imagewise exposed lithographic printing plate precursor was then mounted onto a MAN Roland Favorite 04 press machine without developing (processing). Fountain solution (Varn Supreme 6038) and lithographic printing ink (Gans Cyan) were supplied, and lithographic printing was performed. On-press development occurred during printing. Acceptable on-press developability was observed with a clean background within 15 sheets.

The data provided above in TABLE IV demonstrates the addition of compound P provides the possibility to use much more potent leuco dyes without compromising white light stability and thus generate enhanced printout contrast for on-press developable printing plates.

The invention has been described in detail with particular reference to certain preferred embodiments thereof, but it will be understood that variations and modifications can be effected within the spirit and scope of the invention.

1. A lithographic printing plate precursor comprising an aluminum-containing substrate, and an infrared radiation-sensitive image-recording layer disposed on the aluminum-containing substrate,
the infrared radiation-sensitive image-recording layer comprising:
g) one or more free radically polymerizable components;
h) one or more infrared radiation absorbers;
i) an initiator composition;
j) one or more color-forming compounds;
k) one or more compounds, each being represented by the following Structure (P): 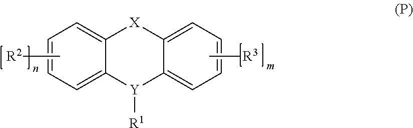
wherein X is the group —O—, —S—, —NH—, or —CH₂—, Y is the group >N— or >CH—, R¹ is hydrogen or a substituted or unsubstituted alkyl, R² and R³ are independently halo, thioalkyl, thiophenyl, alkoxy, phenoxy, alkyl, phenyl, thioacetyl, or acetyl, groups, and m and n are independently 0 or an integer of from 1 to 4; and
l) optionally, a non-free radically polymerizable polymeric material different from the a), b), c), d), and e) components defined above,
wherein the infrared radiation-sensitive image-recording layer, upon exposure to infrared radiation to provide exposed regions and non-exposed regions, exhibits a color contrast between the exposed regions and non-exposed regions of a ΔE greater than 8, and wherein a ΔE of at least 5 is maintained between the exposed regions and the non-exposed regions after storage of the exposed image-recording layer under white light for at least one hour.

2. The lithographic printing plate precursor of claim 1, provided that at least one of the d) one or more color-forming compounds is not a compound represented by the following Structure (C′): 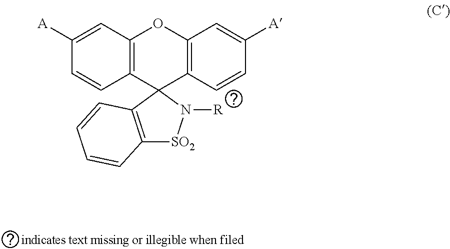
wherein A and A′ are the same or different group represented by the following Structure (AA′): 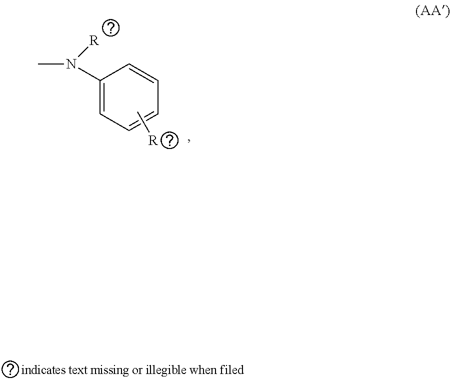
R⁴ is an unsubstituted alkyl group, R⁵ is an unsubstituted alkyl group, and R⁶ is a halogen or an alkyl sulfonyl group.

3. The lithographic printing plate precursor of claim 1, provided that at least one of the d) one or more color-forming compounds is not a compound represented by one of the following Structures (X) and (Y):

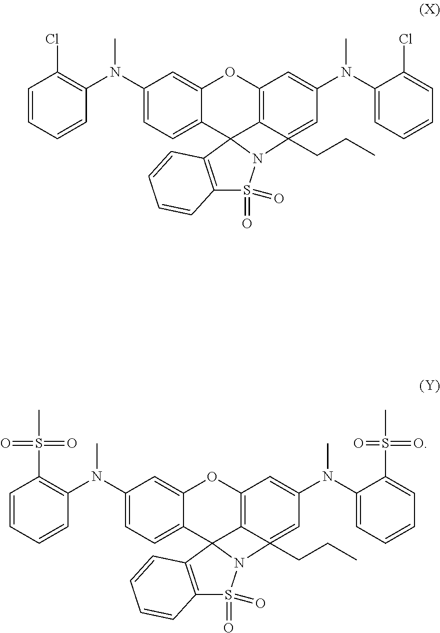

4. The lithographic printing plate precursor of claim 1, wherein at least one of the d) one or more color-forming compounds comprises a lactone substructure.

5. The lithographic printing plate precursor of claim 1, wherein the d) one or more color-forming compounds and the e) one or more compounds represented by Structure (P) are present in the infrared radiation-sensitive image-recording layer at a d) to e) molar ratio of at least 1.1:1 to and including 50:1.

6. The lithographic printing plate precursor of claim 5, wherein the d) one or more color-forming compounds are present in the infrared radiation-sensitive image-recording layer in a dry coverage amount of at least 2 weight % and up to and including 10 weight %.

7. The lithographic printing plate precursor of claim 1, wherein the f) polymeric material is present in particulate form.

8. The lithographic printing plate precursor of claim 1, wherein the infrared radiation-sensitive image-recording layer is the outermost layer.

9. The lithographic printing plate precursor of claim 1, that is on-press developable.

10. The lithographic printing plate precursor of claim 1, wherein the a) one or more free radically polymerizable components comprise at least two free radically polymerizable components.

11. The lithographic printing plate precursor of claim 1, wherein the c) initiator composition comprises a diaryliodonium salt.

12. The lithographic printing plate precursor of claim 1, wherein the aluminum-containing substrate comprises an aluminum oxide layer provided by phosphoric acid anodization, and a hydrophilic polymer coating is disposed on the aluminum oxide layer.

13. The lithographic printing plate precursor of claim 1, wherein X is —S— or —NH—, and Y is >N—.

14. The lithographic printing plate precursor of claim 1, wherein m and n are independently 0, 1, or 2, and R² and R³ are independently a chloro, a thioalkyl having 1 or 2 carbon atoms, or an acetyl, group.

15. The lithographic printing plate precursor of claim 1, wherein the d) one or more color-forming compounds are represented by one or both of the following Structures (C1) and (C2): 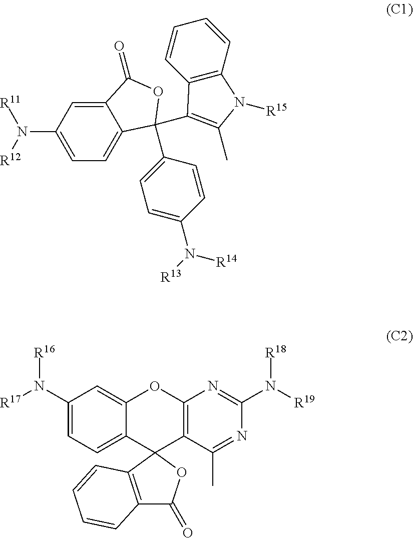
wherein R¹¹ through R¹⁹ are independently hydrogen, unsubstituted or substituted alkyl groups, or unsubstituted or substituted aryl groups.

16. The lithographic printing plate precursor of claim 1, wherein the e) one or more compounds represented by Structure (P) are one or more of the following Compounds 1 through 4:

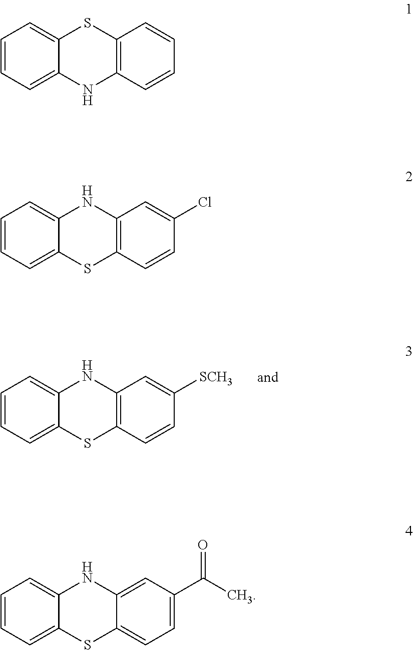 [SMILES: c1ccc2c(c1)Nc1ccccc1S2 ; Clc1ccc2c(c1)Nc1ccccc1S2 ; CSc1ccc2c(c1)Nc1ccccc1S2 ; CC(=O)c1ccc2c(c1)Nc1ccccc1S2]

17. The lithographic printing plate precursor of claim 1, wherein the c) initiator composition comprises a tetraaryl borate.

18. A method for providing a lithographic printing plate, comprising:
A) imagewise exposing the lithographic printing plate precursor according to claim 1 to infrared radiation, to provide exposed regions and non-exposed regions in the infrared radiation-sensitive image-recording layer, and
B) removing the non-exposed regions in the infrared radiation-sensitive image-recording layer from the aluminum-containing substrate.

19. The method of claim 18, comprising removing the non-exposed regions in the infrared radiation-sensitive image-recording layer from the aluminum-containing substrate on-press using a lithographic printing ink, a fountain solution, or a combination of a lithographic printing ink and a fountain solution.

20. A method for providing a lithographic printing plate, comprising:
A) imagewise exposing the lithographic printing plate precursor according to claim 5 to exposing infrared radiation, to provide exposed regions and non-exposed regions in the infrared radiation-sensitive image-recording layer, and
B) removing the non-exposed regions in the infrared radiation-sensitive image-recording layer from the aluminum-containing substrate on-press.
